(19) United States
(12) Patent Application Publication
(10) Pub. No.: US 2009/0110010 A1
(43) Pub. Date: Apr. 30, 2009

(54) FIBER-FOCUSED DIODE-BAR OPTICAL TRAPPING FOR MICROFLUIDIC MANIPULATION

(75) Inventors: Jeff Squier, Golden, CO (US); David W.M. Marr, Golden, CO (US); Robert Applegate, Golden, CO (US); Tor Vestad, Golden, CO (US)

Correspondence Address: SHERIDAN ROSS PC, 1560 BROADWAY, SUITE 1200, DENVER, CO, 80202, US

(73) Assignee: COLORADO SCHOOL OF MINES, Golden, CO (US)

(21) Appl. No.: 12/239,449

(22) Filed: Sep. 26, 2008

Related U.S. Application Data
(60) Provisional application No. 60/975,429, filed on Sep. 26, 2007.

(51) Int. Cl. H01S 3/10

(52) U.S. Cl. 372/9

(57) ABSTRACT

The direct integration of light and optical control into microfluidic systems presents a significant hurdle to the development of portable optical trapping-based devices. A simple, inexpensive fiber-based approach is provided that allows for easy implementation of diode-bars for optical particle separations within flowing microfluidic systems. Models have also been developed that demonstrate the advantages of manipulating particles within flow using linear geometries as opposed to individually focused point traps as traditionally employed in optical-trapping micromanipulation.

### CROSS-REFERENCE TO RELATED APPLICATIONS

This Application claims the benefit of U.S. Provisional Application No. 60/975,429, filed Sep. 26, 2007, the entire disclosure of which is hereby incorporated herein by reference.

### FIELD OF THE INVENTION

The present invention is directed toward methods and devices for manipulating particles within flow using linear geometries.

### BACKGROUND

A laser beam may be focused to a diffraction-limited spot with a high numerical-aperture objective allowing micron-sized objects in solution to be trapped in three dimensions into the region of highest light intensity. In 1970, Ashkin introduced and demonstrated the feasibility of this non-contact manipulation technique, dubbed optical or laser tweezers. Because the focused laser beam encounters an index of refraction mismatch between the particle and surrounding solution light is redirected, which induces a change in light momentum that must be balanced by the object. The net effect of this phenomenon is the immobilization of small micron-sized objects in the laser beam's focus. This tool has received broad interest because it allows non-contact, non-invasive and precise manipulation of objects in solution on the microscopic scale and has been applied in fields including chemistry, biology, colloidal, and polymer science. The utility of optical trapping in these various fields has led to interest in its implementation within microfluidic systems where, for example, direct cell manipulation would be a significant aid (e.g. lab-on-a-chip applications). However, the dynamic nature of such flowing systems, particularly those focused upon microscale separations, demand an optical trapping technique that can be spatially translated.

### SUMMARY

Dynamic optical trapping techniques based on rapidly-scanned mirrors or holographic array generators are powerful and demonstrate the capabilities of optical-based manipulation, however, they require significant associated optical hardware which hinders implementation for biomedical research and medical point of care applications. To overcome this barrier, embodiments of the present invention employ various schemes that take advantage of the nature of microfluidic fluid dynamics and use relatively inexpensive diode laser bars for the manipulation of particles in microscale geometries. This approach allows control of objects within the dimensions of the emitter, typically a 1 mm by 100-200 mm line and is uniquely facilitated by the confining microchannel geometries in which optical trapping occurs. Traditionally, and in non-confining 3D systems, design of the optical trap requires high numerical aperture (NA) objectives and tightly-focused Gaussian beams. This design is driven by the need to create strong optical gradients in the axial-dimension to overcome gravity and optical scattering forces. With a pseudo-2D confining geometry that limits particle translation to a flowing microfluidic plane, optical intensity gradients in the lateral dimensions dominate particle motion thus greatly diminishing optical requirements. Taking full advantage of this, it can be demonstrated that the use of inexpensive cylindrical plastic fibers as the sole optical component required to focus laser radiation for optical trapping-based separations within microchannels.

Thus, a new and effective approach for integrating diode bar based optical trapping within microfluidic geometries using optical fiber is provided herein. Because of the elongated geometry of the emitter, such cylindrical physical systems provide an inexpensive and easily integrated optical focusing tool. To demonstrate its utility the effective trapping forces in flowing microfluidic systems have been measured and compared to model-based predictions. The results demonstrate that line-based optical trapping within confining environments has a number of advantages including significantly reduced local intensities for equivalent trapping forces, preventing damage to cells when this is a design factor. In addition, the optical pressure arising from the low-NA optics employed here produces a push toward the channel wall that can be used advantageously by moving cells to streamlines of lower velocity, lowering drag and the required optical trapping intensities.

In accordance with at least some embodiments of the present invention, a method is provided that generally comprises:
providing a diode emitter;
creating a diode laser bar with the diode emitter, wherein the diode laser bar comprises a predetermined wavelength;
focusing the diode laser bar through a fiber optic element;
directing the focused diode laser bar at a microfluidic flow; and
trapping at least one particle in the microfluidic flow with the focused diode laser bar. In accordance with at least some embodiments of the present invention, an apparatus is also provided that generally comprises:
an emitter operable to produce a laser beam having a predetermined wavelength;
a channel comprising a microfluidic flow of a first fluid; and
a fiber optic element positioned to operably focus the laser beam produced by the emitter on at least a portion of the microfluidic flow through the channel to trap particles in the first fluid.

These and other advantages will be apparent from the disclosure of the invention(s) contained herein. The above-described embodiments and configurations are neither complete nor exhaustive. As will be appreciated, other embodiments of the invention are possible using, alone or in combination, one or more of the features set forth above or described in detail below.

### DESCRIPTION OF THE DRAWINGS

FIG. 1 depicts a series of graphs of high-throughput flow-based optical mechanical testing where dual line optical traps stretch hydrodynamically-focused cells in accordance with at least some embodiments of the present invention;

FIG. 2 depicts a system arrangement for fiber-focused microfluidic trapping integration in accordance with at least some embodiments of the present invention;

FIG. 3 is a graph depicting normalized restoring force and position of force maximum for bar and spot illumination in accordance with at least some embodiments of the present invention; and

FIG. 4 is a graph depicting a comparison to experimental estimates from microfluidic diode-bar flow measurements in accordance with at least some embodiments of the present invention.

### DETAILED DESCRIPTION

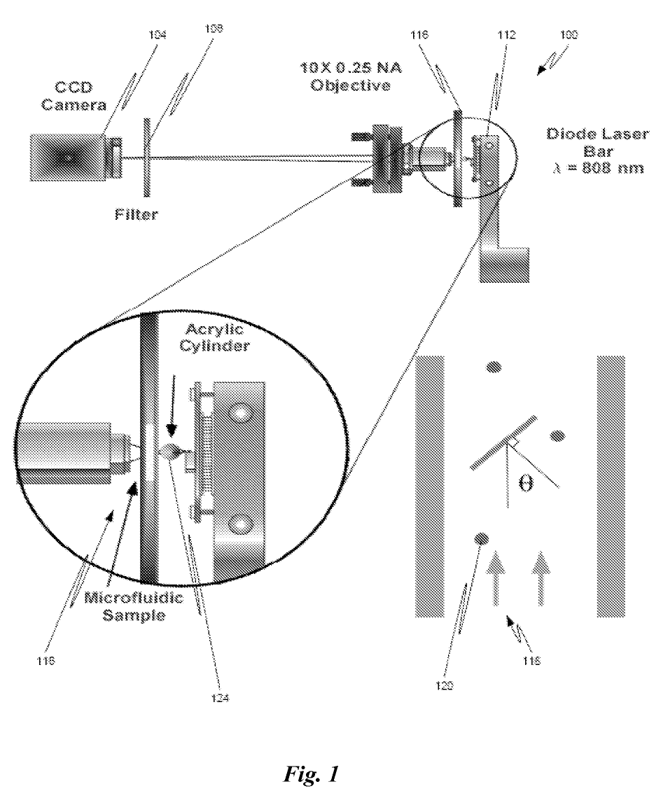

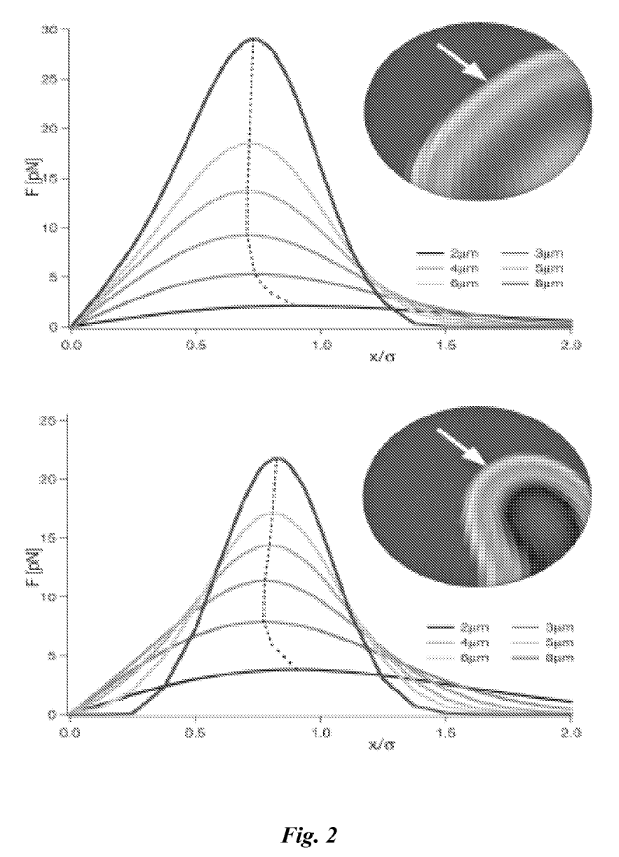

Referring initially to FIG. 1, an exemplary particle manipulation system 100 will be described in accordance with at least some embodiments of the present invention. Diode laser bar trapping studies employed an emitter 112, 200 μm by 1 μm (as produced by Snoc Electronics under LD-005), capable of producing 2W of average power and centered at a wavelength of 808 nm with an integrated cylindrical micro-lens. The emitter 112 output was imaged directly into the microfluidic sample 116 through a 1 mm diameter PMMA (polymethyl methacrylate, n=1.49) (as produced by Industrial Fiber Optics) fiber 124 placed perpendicular to the beam path as can be seen in FIG. 2. More specifically, FIG. 1 depicts high-throughput flow-based optical mechanical testing where dual line optical traps stretch hydrodynamically-focused cells. This small section of fiber 124 allows for focusing in the bar fast axis, the axis used to trap particles 120 in our flowing microfluidic systems 116. The microfluidic sample 116 generally comprises a multiple angle, single channel geometry with only one input and one output, and channel walls enclosing the microfluidic flow. The microfluidic flow 116 and particles 120 contained therein may be viewed through a 10×, 0.25 NA objective with a CCD camera 104 which views the microfluidic sample 116 through an optical filter 108. Excluding sample imaging, the entire optical train can be approximately 1 cm long.

The trapping force was estimated experimentally by gradually increasing microfluidic flow rate at constant laser power (˜750 mW in the sample plane) until the particles within the flow passed through the laser trap at near zero velocity despite the applied optical force. At this point the trapping force is approximately balanced with the drag force of the flowing fluid estimated using a CCD camera and particle distances measured between frames taken every 1/30th of a second. Different trap angles (0°, 20°, 30°, 45°, 60°) relative to flow were used in our measurements with the component of the resulting force vector in the direction normal to the line trap averaged to obtain the experimental value for a given particle size.

To determine net restoring forces with varying illumination geometries, a modeling approach can be used that allows calculation of local stress, which can be integrated to obtain desired values. This approach may be based on the modeling of cell “stretching” forces where the classic Mie ray optics approach is extended to calculation of local stress profiles across the front and back sphere surfaces. In calculations, the laser light source may be treated as an infinite number of rays coming in parallel to the vertical axis with the field modeled using a Gaussian with a spot of tunable size and focus position:

$$E ( x , y , z ) = \frac{{ω}_{0}}{ω ( z )} {e}^{- \frac{( {( x - {x}_{0} )}^{2} + {y}^{2} )}{{ω ( z )}^{2}}} {e}^{- i [ k ( z + \frac{{( x - {x}_{0} )}^{2} + {y}^{2}}{2 {R}_{c} ( z )} ) - ϛ ( z ) ]}$$

$$ω ( z ) = {ω}_{0} \sqrt{1 + {( \frac{z}{{z}_{0}} )}^{2}}$$

where ω₀ is the minimum spot size, k is the wavenumber, Rc is the radius of curvature of the Gaussian beam, and ζ is the Guoy phase term. The reflectance and transmittance (T=1−R_{R}) may be taken into account due to the cell front and back interfaces, using the polarization-dependent Fresnel equations:

$${R}_{R ⊥} = {( \frac{{n}_{m} cos {φ}_{0} - {n}_{p} cos β}{{n}_{m} cos {φ}_{0} + {n}_{p} cos β} )}^{2} {R}_{RP} = {( \frac{{n}_{m} cos β - {n}_{p} cos {φ}_{0}}{{n}_{m} cos β + {n}_{p} cos {φ}_{0}} )}^{2} ;$$

$${R}_{R} = \frac{{R}_{R ⊥} + {R}_{RP}}{2}$$

where φ₀ and β are the front and back ray angles relative to the normal and the n are the refractive indices. In this model, the net force at each position on the cell surface is the change in momentum of the incident ray minus those of the transmitted and reflected rays. To simplify calculations multiple reflections may be neglected and have verified results quantitatively by integration of the calculated local stress over the top and bottom surfaces, obtaining the net trapping force and comparing these to results available in the literature.

Experiments demonstrate that optical fiber can be used as an inexpensive means of focusing line-trap illumination within microfludic systems. Qualitatively, smaller fiber provides a tighter focus and more efficient optical trapping but is more difficult to couple to the emitter leading to greater losses. In accordance with at least some embodiments of the present invention, a 1 mm diameter fiber provides a balance between NA (providing a value of ˜0.55 in air) and light collection with minimal losses. As illustrated in FIG. 1, a fiber external 124 to the microfluidic sample 116 may be employed; however, due to the low cost, fiber focusing could be readily incorporated directly into the disposable PDMS (i.e., microfluidic sample) matrix at approximately one-third the NA with these specific materials.

In traditional implementation of the optical trapping technique, high-index particles are driven to the center of the trap focus where the net force is zero. In the flowing systems used here with the additional drag forces present, pseudo-equilibrium will occur at positions offset from the trap and particle center. FIG. 1 depicts a system arrangement for fiber-focused microfluidic trapping integration. Inset includes illustration of diode bar optical trap within microfluidic flow channel.

FIG. 2 represents net calculated restoring force predictions as either bar (750 mW/200 μm) or spot (30 mW/3 μm) illumination is translated away from the particle center. Here, and as expected, a maximum is observed as the trap is moved away from the center where net forces balance, to the particle edge where illumination intensity diminishes. It is this predicted maximum that we take as the effective trapping force in flow. One very useful observation from this calculation is that one obtains an equivalent trapping force by moving to a line-source with local intensity no more than half that of the local intensity in the spot case. Such reduced local intensities available from non point-source optical traps could prove significant in preventing damage to cells in systems where strong optical forces are required.

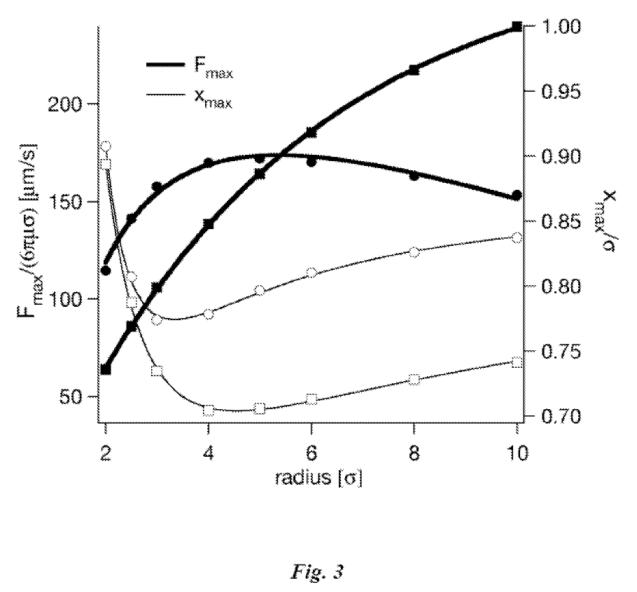

FIG. 3 highlights the position and relative strength of the extracted restoring force maximum as a function of particle size. FIG. 3 depicts normalized restoring force and position of force maximum for bar (▪□) and spot (◯) illumination. Note here the balance between the restoring force and the drag force as one moves towards larger particle sizes. In the case of spot illumination, drag begins to dominate for the larger particle sizes whereas bar-based sources continue to be controlled by trapping forces even as the size increases.

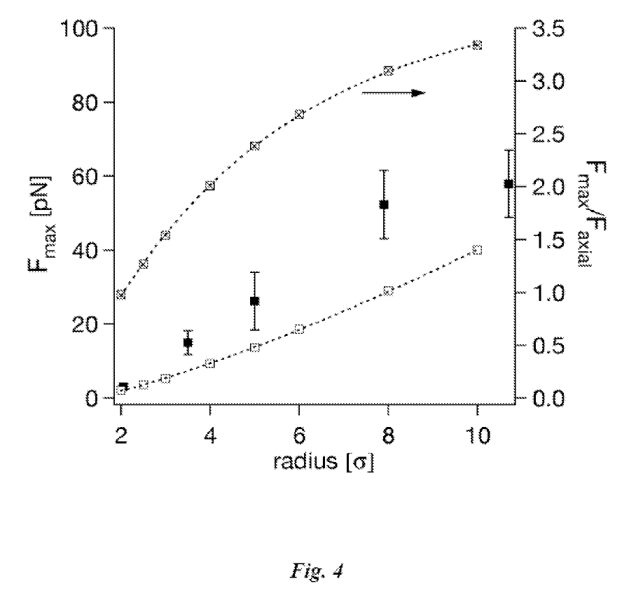

Though one goal of the present invention is to demonstrate the utility of fiber-based diode-bar focusing, current modeling approaches allow quantitative prediction of trapping force for a given particle size and diode laser intensity. When comparing our predictions and those values determined experimentally a number of corrections and assumptions must be made. Experimental measurements consist of particle velocity from which an estimated maximum restoring force is extracted using values for the Stokes drag on a sphere. It is well known however that the Stokes drag is modified in the presence of confining plates. In addition, as quantified in the calculations of FIG. 4, there are optical forces pushing the particles toward the wall where drag is further enhanced. FIG. 4 more specifically depicts a comparison to experimental estimates from microfluidic diode-bar flow measurements. Predictions of restoring vs. wall forces (□) with varying particle size. Following Miwa, et al., and assuming the colloids are translated next to the surface we apply corrections for both wall confinement and proximity. To obtain an estimate of the trapping force in the direction of flow however, the local fluid velocity at the particle position is also required. Here we assume a parabolic profile between confining surfaces with maximum velocity given by the particle velocity upon entering the trap. Finally, it should be noted that the intensity profile along the beam length is not constant as the beam diverges within the trapping plane due to the fiber-based focusing and the square profile from the emitter evolves towards a sinc profile within the trapping plane. Our experimental measurements were therefore performed near the bar center and a correction of ˜30% used for comparison to our modeling predictions based on average bar intensity. Despite the approximate nature of this approach, comparison between these experimental estimates and theory show similar trends and reasonable quantitative agreement. Also shown in FIG. 4 is the relative strength of the restoring force to the axial force for the 3 mm wide bar as one progresses from smaller to larger particles. Though calculations are based on our specific low-NA optics, it can be seen that axial forces become significantly less important relative to trapping forces as particle size is increased.

The present invention, in various embodiments, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, includes providing devices and processes in the absence of items not depicted and/or described herein or in various embodiments hereof, including in the absence of such items as may have been used in previous devices or processes, e.g., for improving performance, achieving ease and\or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments for the purpose of streamlining the disclosure. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the invention.

Moreover though the description of the invention has included description of one or more embodiments and certain variations and modifications, other variations and modifications are within the scope of the invention, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A method of manipulating in-solution objects, comprising:
providing a diode emitter;
creating a diode laser bar with the diode emitter, wherein the diode laser bar comprises a predetermined wavelength;
focusing the diode laser bar through a fiber optic element;
directing the focused diode laser bar at a microfluidic flow; and
trapping at least one particle in the microfluidic flow with the focused diode laser bar.

2. The method of claim 1, wherein the diode laser bar is focused in a generally perpendicular orientation with respect to a direction of the microfluidic flow.

3. The method of claim 1, wherein the microfluidic flow comprises a multiple angle, single channel geometry having at least a first input and at least a first output.

4. The method of claim 1, wherein the fiber optic element has a diameter between about 0.5 mm-1.5 mm.

5. The method of claim 1, wherein the fiber optic element is positioned external to the microfluidic flow.

6. The method of claim 1, wherein the fiber optic element is incorporated within the microfluidic flow.

7. The method of claim 1, further comprising stretching the at least one particle with optical forces provided by the focused diode laser bar.

8. An optical trapping device, comprising:
an emitter operable to produce a laser beam having a predetermined wavelength;
a channel comprising a microfluidic flow of a first fluid; and
a fiber optic element positioned to operably focus the laser beam produced by the emitter on at least a portion of the microfluidic flow through the channel to trap particles in the first fluid.

9. The device of claim 8, wherein the predetermined wavelength comprises about 808 nm.

10. The device of claim 8, wherein the fiber optic element comprises a diameter between about 0.5 mm and 1.5 mm.

11. The device of claim 8, wherein the fiber optic element is comprised at least in part of a polymethyl methacrylate material.

12. The device of claim 8, wherein the fiber optic element is oriented substantially perpendicular with respect to the channel and the direction of the microfluidic flow.

13. The device of claim 8, wherein an equivalent trapping force is obtained by moving to a line-source with local intensity no more than half that of the local intensity in a spot case.

14. The device of claim 8, wherein the microfluidic flow imposes drag forces on the particles in the first fluid and wherein pseudo-equilibrium between the drag forces and optical forces imposed by the fiber optic element occurs at positions offset from the trap and particle center.

15. The device of claim 14, wherein the optical forces urge the particle toward a wall of the channel.

16. The device of claim 8, wherein an intensity profile along the beam length is not constant as the beam diverges within a trapping plane due to the fiber-based focusing.

17. The device of claim 8, wherein the beam comprises a square profile at the fiber optic element and wherein the square profile evolves towards a sinc profile within the trapping plane as the beam diverges from the fiber optic element.

18. A device, comprising:
a diode emitter operable to create a diode laser bar having a predetermined wavelength that is higher than the wavelength of visible light; and
a fiber optic element operable to focus the diode laser bar created by the diode emitter and direct the focused diode laser bar on at least one particle flowing within a microfluidic flow such that the at least one particle can be trapped with optical forces within the microfluidic flow and manipulated with the optical forces, wherein the fiber optic element comprises a diameter between about 0.5 mm and 1.5 mm, wherein the fiber optic element is comprised at least in part of a polymethyl methacrylate material, and wherein the fiber optic element is oriented substantially perpendicular with respect to the channel and the direction of the microfluidic flow.

19. The device of claim 18, wherein the beam comprises a square profile at the fiber optic element and wherein the square profile evolves towards a sinc profile within the trapping plane as the beam diverges from the fiber optic element.

20. The device of claim 18, wherein the fiber optic element is oriented substantially perpendicular with respect to the channel and the direction of the microfluidic flow.
